(19) United States
(12) Patent Application Publication
(10) Pub. No.: US 2026/0017788 A1
(43) Pub. Date: Jan. 15, 2026

(54) ANALYSIS DEVICE, PREDICTION SYSTEM, AND PREDICTION METHOD

(71) Applicants: TOPPAN Holdings Inc., Tokyo (JP); National University Corporation Tokai National Higher Education and Research System, Nagoya-shi (JP)

(72) Inventors: Kenichi SAKANE, Tokyo (JP); Shiro KITANO, Tokyo (JP); Hisami UENO, Tokyo (JP); Ryuji KATO, Nagoya-shi (JP); Kenjiro TANAKA, Nagoya-shi (JP); Saki HAYASHI, Nagoya-shi (JP)

(73) Assignees: TOPPAN Holdings Inc., Tokyo (JP); National University Corporation Tokai National Higher Education and Research System, Nagoya-shi (JP)

(21) Appl. No.: 19/335,634

(22) Filed: Sep. 22, 2025

Related U.S. Application Data
(63) Continuation of application No. PCT/JP2024/011453, filed on Mar. 22, 2024.

(30) Foreign Application Priority Data
Mar. 24, 2023 (JP) 2023-047986

(51) Int. Cl. G06T 7/00; G06T 7/50; G06T 7/60; G06V 10/75; G06V 10/774; G06V 20/69

(52) U.S. Cl. CPC G06T 7/0012; G06T 7/50; G06T 7/60; G06V 10/75; G06V 10/774; G06V 20/695; G06T 2207/20081; G06T 2207/30024; G06T 2207/30101; G06V 2201/03

(57) ABSTRACT

A first acquisition unit configured to acquire cell feature data indicating a feature of a training cell that is a cell to be a cell tissue having a vascular network structure based on a cell image obtained by imaging the training cell, a second acquisition unit configured to acquire tissue feature data indicating a feature of a training tissue that is a cell tissue produced by culturing the training cell, and a generation unit configured to generate correspondence data in which the cell feature data and the tissue feature data are associated with each other are provided.

### CROSS-REFERENCE TO RELATED APPLICATIONS

This application is a Continuation Application based on International Application No. PCT/JP2024/011453, filed Mar. 22, 2024, which claims priority on Japanese Patent Application No. 2023-047986, filed Mar. 24, 2023, the contents of which are incorporated herein by reference.

### TECHNICAL FIELD

The present disclosure relates to an analysis device, a prediction system, and a prediction method.

### BACKGROUND ART

There is a technology of evaluating drug efficacy by using a cell tissue. For example, as a technology of evaluating an effect of an anti-cancer agent, Patent Document 1 discloses a technology of creating a three-dimensional cell tissue in which cells are cultured and are made to coexist with stroma such as endothelial cells or fibroblasts that coexists with cancer cells. A three-dimensional cell tissue in which a cancer cell has been seeded is cultured, and an anti-cancer agent is administered thereto. As a result, it is possible to evaluate the effect of an anti-cancer agent on cancer cells present in a three-dimensional cell tissue that is closer to a living body than cells cultured on a flat plate.

### CITATION LIST

### Patent Document

Patent Document 1: PCT International Publication No. WO2019/039452

### SUMMARY OF INVENTION

### Technical Problem

However, it takes many days, for example, approximately 10 days to 20 days, from starting the culture of the cells to obtaining the results of the evaluation. Moreover, a tissue that is not suitable for the evaluation may be produced in cells cultured over a long period of time, and in this case, valuable specimens such as cancer cells and anti-cancer agents are wasted. Furthermore, since the culture has to be restarted from the beginning, the number of days required for evaluating the drug efficacy further increases.

The present disclosure has been made in view of such circumstances, and an object of the present disclosure is to provide an analysis device, a prediction system, and a prediction method that can predict characteristics of a cell tissue to be produced from cells at an initial stage of starting culture of the cells.

### Solution to Problem

An analysis device according to a first aspect of the present disclosure includes: a first acquisition circuitry configured to acquire cell feature data indicating a feature of a training cell that is a cell to be a cell tissue having a vascular network structure based on a cell image obtained by imaging the training cell; a second acquisition circuitry configured to acquire tissue feature data indicating a feature of a training tissue that is a cell tissue produced by culturing the training cell; and a generation circuitry configured to generate correspondence data in which the cell feature data and the tissue feature data are associated with each other.

A prediction system according to a second aspect of the present disclosure includes: the analysis device according to the first aspect; a trained model generation circuitry configured to generate a trained model for predicting a feature of a cell tissue to be produced from a target cell based on a target cell image obtained by imaging the target cell that is an estimation target by causing a learning model to learn a correspondence relationship between the cell and the cell tissue by using the correspondence data generated by the analysis device as a training data set; a third acquisition circuitry configured to acquire target cell feature data based on the target cell image, and a prediction circuitry configured to predict the feature of the cell tissue to be produced by culturing the target cell by using the trained model generated by the trained model generation circuitry.

A prediction method according to a third aspect of the present disclosure is a prediction method to be executed by a computer, the method including: acquiring, by a first acquisition circuitry, cell feature data indicating a feature of a training cell that is a cell to be a cell tissue having a vascular network structure based on a cell image obtained by imaging the training cell; acquiring, by a second acquisition circuitry, tissue feature data indicating a feature of a training tissue that is a cell tissue produced by culturing the training cell; generating, by a generation circuitry, correspondence data in which the cell feature data and the tissue feature data are associated with each other; generating, by a trained model generation circuitry, a trained model that predicts a feature of a cell tissue to be produced from a target cell based on a target cell image obtained by imaging the target cell that is an estimation target by causing a learning model to learn a correspondence relationship between the cell and the cell tissue by using the correspondence data as a training data set; acquiring, by a third acquisition circuitry, target cell feature data based on the target cell image; and predicting, by a prediction circuitry, the feature of the cell tissue to be produced by culturing the target cell by using the trained model generated by the trained model generation circuitry.

### Advantageous Effects of Invention

According to the above-described aspects of the present disclosure, it is possible to predict characteristics of a cell tissue to be produced from a cell in an initial stage of starting culture of the cell.

### BRIEF DESCRIPTION OF DRAWINGS

FIG. 1 A block diagram showing an example configuration of a prediction system according to an embodiment.

FIG. 2 A diagram showing a training data set of the embodiment.

FIG. 3 A diagram showing an example of a tissue of the embodiment.

FIG. 4 A diagram showing processes performed by the prediction system of the embodiment.

FIG. 5 A diagram showing an example of training cell images of the embodiment.

FIG. 6 A diagram showing an example of training tissue images of the embodiment.

FIG. 7 A diagram showing an example of training tissue images of the embodiment.

FIG. 8 A diagram showing an example of quality evaluation of training tissue images of the embodiment.

FIG. 9 A diagram showing an example of quality evaluation of training tissue images of the embodiment.

FIG. 10 A diagram showing an example of quality evaluation of the training tissue images of the embodiment.

FIG. 11 A diagram showing an example of quality evaluation of the training tissue images of the embodiment.

FIG. 12 A diagram showing an example of quality evaluation of the training tissue images of the embodiment.

FIG. 13 A sequence diagram showing a flow of a process performed by the prediction system of the embodiment.

### DESCRIPTION OF EMBODIMENTS

Hereinafter, embodiments of the present disclosure will be described with reference to the drawings. In the following description, a case where a feature of a tissue (tissue feature data described below) is acquired based on an image (training tissue image GF described below) will be described as an example, but the present disclosure is not limited thereto. For example, a measurement result obtained by measuring a shape of a tissue or the like without using an image, or a result obtained by evaluating a quality of the tissue by a skilled person through visual observation or the like may be used as the tissue feature data. By acquiring the tissue feature data based on a quantitative index, it is possible to manage the quality of the tissue, which it is inherently difficult to manage due to a large variation. In addition, in the following description, a case of predicting the quality or the like of the tissue by using a prediction model will be described as an example, but the present disclosure is not limited thereto. It is sufficient that at least the quality of a cell or a tissue can be quantitatively managed. For example, by generating a database in which the features of the cell and the tissue are associated, it is possible to quantitatively manage the quality of the cell or the tissue. As a result, it is possible to stabilize a step of creating a tissue from cells, and moreover, in the embodiment, it is possible to acquire the feature of each of the cell and the tissue in a non-destructive and non-invasive manner. Therefore, it is possible to quantitatively evaluate living cells or living tissues.

### (Regarding Prediction System 1)

A prediction system 1 is a system that predicts characteristics of a cell tissue to be produced from cells. In the present embodiment, a case where a cell tissue having a vascular network structure is targeted will be described as an example, but the present disclosure is not limited thereto. The prediction system 1 is applicable to prediction of the characteristics in any cell tissue to be produced from cells.

Hereinafter, the cell tissue may be simply referred to as a “tissue”.

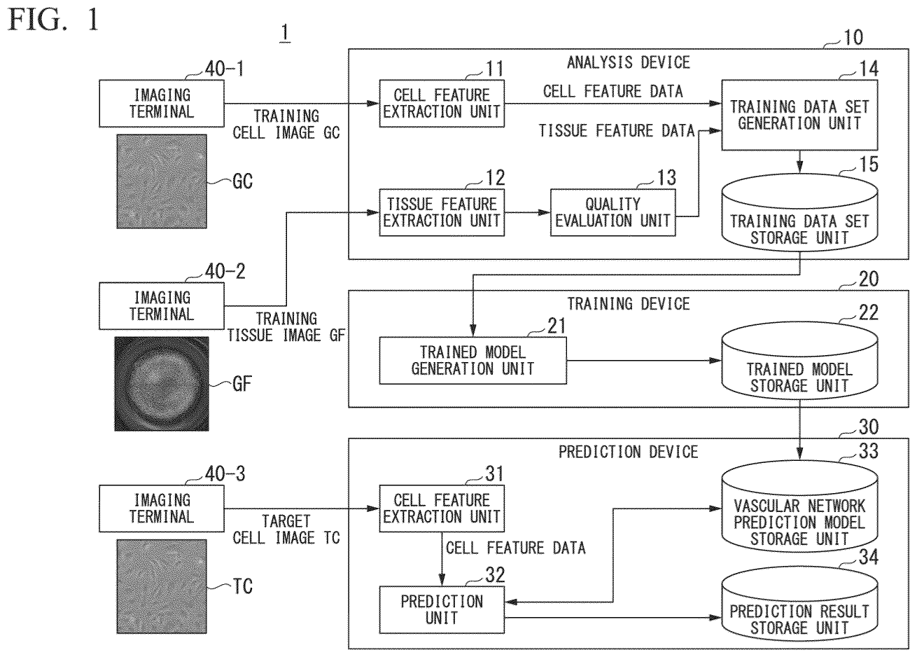

FIG. 1 is a block diagram showing an example configuration of the prediction system 1 according to the embodiment. The prediction system 1 includes, for example, an analysis device 10, a training device 20, a prediction device 30, and an imaging terminal 40 (imaging terminals 40-1 to 40-3).

The analysis device 10 is a computer, and for example, a server device, a cloud, a personal computer (PC), or the like can be applied thereto. The analysis device 10 generates a training data set. The training data set is data for training a learning model, and is information in which an input and an output are associated with each other to be a set (a pair).

The input here is information to be input to the learning model when the learning model is trained. The output is information indicating a correct answer that the learning model should output with respect to the input. In a process of training a learning model with a training data set, the learning model adjusts internal parameters of the learning model such that a correct output is output with respect to an input. The learning model learns a correspondence relationship between an input and an output by learning a large number of training data sets, and can output an output (a prediction value with high accuracy) close to a correct answer for an unlearned input. The learning model that can output the prediction value with high accuracy for the unlearned input is adopted as a trained model.

In the present embodiment, the training data set to be generated by the analysis device 10 is information in which cell feature data as an input and tissue feature data as an output are associated with each other. The training data set is an example of “correspondence data”. The cell feature data is information indicating a feature of a cell. Details of the cell feature data will be described later. The tissue feature data is information indicating a feature of a tissue. Details of the tissue feature data will be described later.

The training device 20 is a computer, and for example, a server device, a cloud, a personal computer (PC), or the like can be applied thereto. The training device 20 generates a trained model. The trained model is a model that is trained to predict an output (tissue feature data) for an unlearned input (cell feature data). The training device 20 causes the learning model to learn the training data set generated by the analysis device 10 to cause the learning model to learn a correspondence relationship between the input (cell feature data) and the output (tissue feature data). As a result, the trained model is generated.

The prediction device 30 is a computer, and for example, a server device, a cloud, a personal computer (PC), or the like can be applied thereto. The prediction device 30 predicts an output (tissue feature data) for an input (cell feature data) using the trained model generated by the training device 20. As a result, it is possible to predict the characteristics of a tissue to be produced from cells at an initial stage of starting culture of the cells.

The imaging terminal 40 is a computer that performs imaging, and for example, a digital camera or a communication device including a camera module such as a mobile phone, a smartphone, or a tablet terminal can be applied thereto. The imaging terminal 40 captures an imaging target and acquires a captured image. Note that when imaging the imaging target, an image in which the imaging target is enlarged by using a microscope may be captured. In a case where the imaging target is a cell or a tissue, it is desirable to capture an image enlarged to an extent that the feature of the cell or the tissue can be analyzed.

The imaging target stated here is a training cell, a training tissue, and a target cell. The training cell is a cell that can be a specific tissue, for example, a cell tissue having a vascular network structure, and is a cell to be used in the training data set. The training tissue is a tissue produced from the training cell. The target cell is a prediction target, and is a cell for predicting the characteristics of a tissue to be produced from the target cell.

Note that in FIG. 1, an example of a case where the imaging terminal 40-1 captures the training cell, the imaging terminal 40-2 captures the training tissue, and the imaging terminal 40-3 captures the target cell is shown, but the present disclosure is not limited thereto. All or a combination of the training cell, the training tissue, and the target cell may be captured by one imaging terminal 40.

### (Regarding Analysis Device 10)

As shown in FIG. 1, the analysis device 10 includes, for example, a cell feature extraction unit 11, a tissue feature extraction unit 12, a quality evaluation unit 13, a training data set generation unit 14, and a training data set storage unit 15.

The cell feature extraction unit 11 acquires cell feature data indicating a feature of a training cell based on a training cell image GC. The training cell image GC is an image in which the training cell is imaged. The training cell is a cell that can be a specific tissue, for example, a cell tissue having a vascular network structure. The training cell image GC is used as an input of the training data set. The cell feature extraction unit 11 acquires the training cell image GC captured by the imaging terminal 40-1 and performs image processing or the like on the acquired training cell image GC to acquire the cell feature data. The cell feature extraction unit 11 outputs the acquired cell feature data to the training data set generation unit 14.

The tissue feature extraction unit 12 acquires tissue feature data indicating a feature of a training tissue based on a training tissue image GF. The training tissue image GF is an image in which the training tissue is imaged. The training tissue is a cell tissue produced by culturing the training cell. The training tissue image GF is used as an output of the training data set. The tissue feature extraction unit 12 acquires the training tissue image GF captured by the imaging terminal 40-2 and performs image processing or the like on the acquired training tissue image GF to acquire tissue feature data. The tissue feature extraction unit 12 outputs the acquired tissue feature data to the quality evaluation unit 13.

The quality evaluation unit 13 evaluates the quality of a tissue. The quality evaluation unit 13 acquires the tissue feature data from the tissue feature extraction unit 12, and determines that the quality is good, for example, when the amount of formation of a vascular network as a tissue is equal to or greater than a threshold value based on the acquired tissue feature data. Alternatively, the quality evaluation unit 13 may acquire a result obtained by evaluating the quality of the tissue by a human by visual observation or the like. In addition, the quality evaluation unit 13 may acquire a result obtained by evaluating the quality of the tissue based on the training tissue image GF by a machine learning method. Note that the quality evaluation unit 13 may determine the quality of the tissue based on a binary value of whether the quality is good or bad, or may determine the quality of the tissue based on a plurality of stages such as good, slightly good, and bad.

The training data set generation unit 14 generates a training data set. The training data set generation unit 14 generates the training data set by associating the cell feature data as an input with the tissue feature data as an output. That is, the tissue feature data as the output is data related to a tissue produced from cells from which the cell feature data as the input is acquired. The training data set generation unit 14 stores the generated training data set in the training data set storage unit 15.

The training data set storage unit 15 stores the training data set. The training data set storage unit 15 is configured by a storage medium such as a hard disk drive (HDD), a flash memory, an electrically erasable programmable read only memory (EEPROM), a random access read/write memory (RAM), and a read only memory (ROM), or a combination thereof.

### (Regarding Training Device 20)

As shown in FIG. 1, the training device 20 includes, for example, a trained model generation unit 21 and a trained model storage unit 22. The trained model generation unit 21 generates a trained model. The trained model generation unit 21 generates the trained model by causing the learning model to learn a correspondence relationship between a cell and a tissue by using the training data set. The trained model generation unit 21 stores information indicating the generated trained model, for example, parameter set values inside the model, in the trained model storage unit 22. The trained model storage unit 22 stores information indicating the trained model generated by the trained model generation unit 21. The trained model storage unit 22 is configured by a storage medium such as an HDD, a flash memory, an EEPROM, a RAM, and a ROM, or a combination thereof.

Note that as the learning model, for example, a model applied to existing machine learning such as deep learning using a convolutional neural network (CNN), a deep CNN (DCNN), a decision tree, hierarchical Bayesian, or a support vector machine (SVM) may be used.

### (Regarding Prediction Device 30)

As shown in FIG. 1, the prediction device 30 includes, for example, a cell feature extraction unit 31, a prediction unit 32, a vascular network prediction model storage unit 33, and a prediction result storage unit 34.

The cell feature extraction unit 31 acquires cell feature data indicating a feature of a target cell based on a target cell image TC. The target cell image TC is an image in which the target cell is imaged. The target cell is a cell for predicting the quality of a tissue produced from the cell. The cell feature extraction unit 31 acquires the target cell image TC captured by the imaging terminal 40-3, and performs image processing or the like on the acquired target cell image TC to acquire cell feature data. The cell feature extraction unit 31 outputs the acquired cell feature data to the prediction unit 32.

The prediction unit 32 uses an output obtained by inputting the cell feature data of the target cell to the vascular network prediction model as the quality of a tissue to be produced from the target cell. The vascular network prediction model is a model that predicts the quality of the tissue to be produced from the cell based on the cell feature data, and is a trained model stored in the trained model storage unit 22. The prediction unit 32 acquires information on the trained model to be used for the vascular network prediction model with reference to the trained model storage unit 22, and stores the information in the vascular network prediction model storage unit 33. The prediction unit 32 constructs the vascular network prediction model with reference to the vascular network prediction model storage unit 33. The prediction unit 32 inputs the cell feature data acquired from the cell feature extraction unit 31 to the vascular network prediction model, and acquires an output value output from the vascular network prediction model.

For example, the vascular network prediction model outputs information indicating the quality of the tissue to be produced from the cell and a degree that obtaining the quality is estimated, for example, information indicating that a probability that a tissue having good quality is produced is 70% and a probability that a tissue having bad quality is produced is 30%.

The prediction unit 32 uses the output value output from the vascular network prediction model as a prediction result. The prediction unit 32 stores the prediction result in the prediction result storage unit 34. The vascular network prediction model storage unit 33 stores information indicating the vascular network prediction model. The prediction result storage unit 34 stores the prediction result predicted by the prediction unit 32. The vascular network prediction model storage unit 33 and the prediction result storage unit 34 are configured by a storage medium such as an HDD, a flash memory, an EEPROM, a RAM, and a ROM, or a combination thereof.

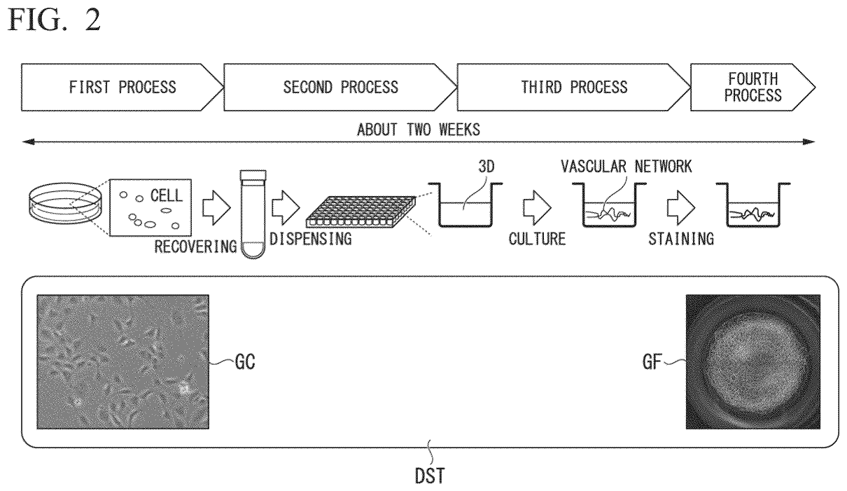

Here, the training data set (cell feature data and tissue feature data) of the present embodiment will be described with reference to FIGS. 2 to 8.

First, a process of producing the cell tissue and a relationship between the cell tissue and the training data set will be described with reference to FIG. 2. FIG. 2 is a diagram showing the training data set of the embodiment.

As shown in FIG. 2, the process of producing the cell tissue includes, for example, a plurality of processes from a first process to a fourth process, and it takes approximately two weeks in order to go through all the processes.

The first process is a process of performing pre-culture. The pre-culture is a process of culturing cells on a flat plate before producing a three-dimensional cell tissue. For example, in the first process, the cells are cultured on the flat plate.

The second process is a process of forming the three-dimensional cell tissue from the cells cultured on the flat plate. For example, in the second process, the cells cultured in the first process are collected and recovered, and thereby a cell aggregate is formed on a substrate. Here, the cells cultured in the first process may be dispensed to produce a plurality of three-dimensional cell tissues.

The third process is a process of culturing the three-dimensional cell tissue to form a vascular network. In the third process, the vascular network as a cell tissue is formed by culturing the cell aggregate formed on the substrate in the second process. As a result, a cell tissue is produced.

The fourth process is a process of evaluating the cell tissue. In the fourth process, the vascular network as the cell tissue is visualized by staining or the like, and the quality of the vascular network is evaluated by visual observation or the like.

Here, an image obtained by imaging the cells cultured in the first process is the training cell image GC. In addition, an image obtained by imaging the cell tissue, for example, the stained vascular network, in the fourth process is the training tissue image GF.

For example, the cell feature data is the training cell image GC. The tissue feature data is the training tissue image GF. In this case, a training data set DST is information in which the training cell image GC and the training tissue image GF are associated with each other.

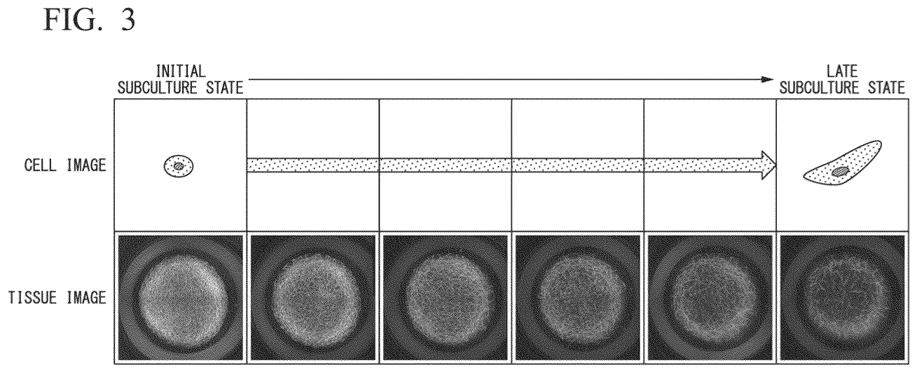

Next, it will be described with reference to FIG. 3 that there is a correlation or the like between a plurality of types of data included in training data (training data set in the present embodiment). FIG. 3 is a diagram showing an example of a tissue according to the embodiment.

FIG. 3 schematically shows a cell image and a tissue image corresponding to several specific subcultures from an initial subculture state to a late subculture state. As shown in FIG. 3, cells in the initial subculture state have a well-formed shape, whereas cells in the late subculture state are enlarged and the shape thereof collapses. In this way, in a case where the subculture is repeated, the shape (appearance) of the cells changes.

In addition, it is shown that many vascular networks are formed in a tissue (a tissue having a vascular network structure) produced from cells in the initial subculture state in which the number of subcultures is small, whereas almost no vascular network is formed in a tissue produced from cells in the late subculture state, and it is difficult to form the vascular network. From the example in this drawing, it can be seen that the shape of the cells changes in a case where the subculture is repeated, and the vascular network tends to be difficult to be formed in a tissue produced from the cells whose shape has changed. Therefore, it can be said that there is a high possibility of a correlation being between appearance of cells and the quality of a tissue produced from the cells. That is, it is considered that there is a correlation between the training cell image GC and the training tissue image GF included in the training data set in the present embodiment.

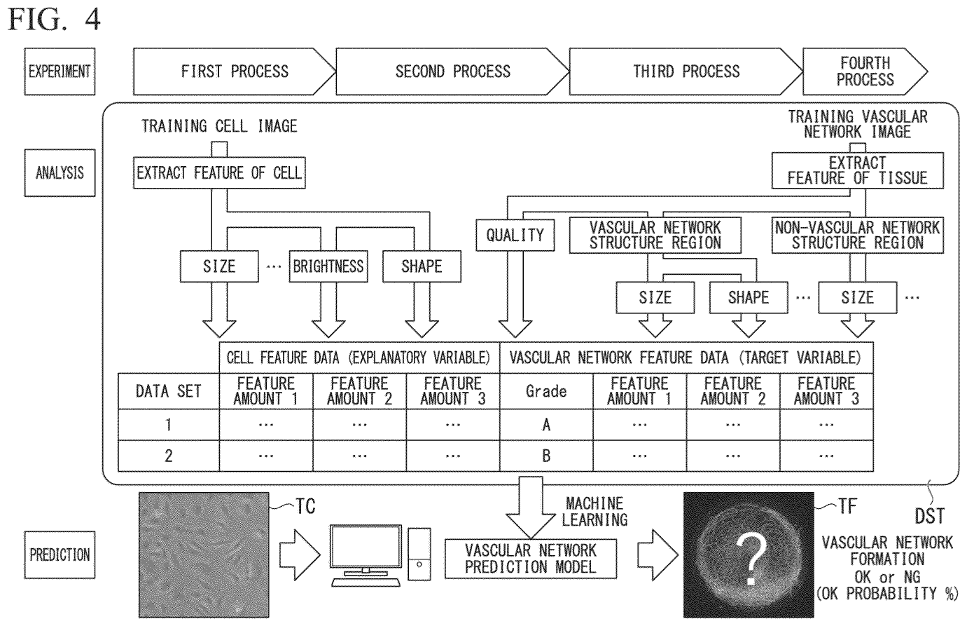

Next, an application example of the training data set will be described with reference to FIG. 4. FIG. 4 is a diagram showing a training data set of the embodiment.

Since a process of producing a cell tissue shown in FIG. 4 is the same as that of FIG. 2, description thereof will be omitted. As shown in FIG. 4, in the present embodiment, the vascular network prediction model is generated through each phase of experiment, analysis, and prediction.

In the phase of the experiment, a tissue is actually produced from cells, and the training cell image GC and the training tissue image GF are acquired in a process of production.

In the analysis phase, cell feature data is acquired from the training cell image GC, tissue feature data is acquired from the training tissue image GF, and the cell feature data and the tissue feature data are associated with each other to generate the training data set DST.

In the prediction phase, the quality of a tissue (vascular network) to be produced from cells from which the target cell image TC is acquired is predicted to be good or bad based on the target cell image TC by using the vascular network prediction model generated by executing machine learning using the training data set DST.

Here, a process of acquiring the cell feature data from the training cell image GC, which is performed in the analysis phase, will be further described. As shown in FIG. 4, the feature of cells, which is extracted from the training cell image GC, may be used as the cell feature data. In this case, the cell feature extraction unit 11 of the analysis device 10 acquires the feature of the cells from the training cell image GC. The cell feature extraction unit 11 acquires, for example, a statistic of a size, brightness, or a shape of the cells imaged in the training cell image GC as the cell feature data.

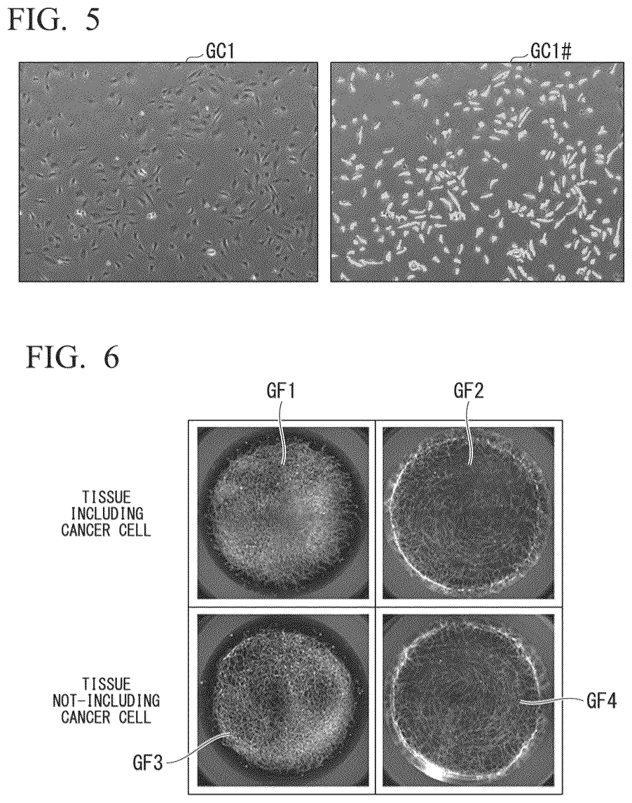

The cell feature extraction unit 11 performs, for example, image processing of extracting cell portions on the training cell image GC to specify a region where cells are imaged in the image. For example, the cell feature extraction unit 11 generates a training cell image GC1 # (refer to FIG. 5) in which a region where the cells are imaged is specified from a training cell image GC1 (refer to FIG. 5).

The cell feature extraction unit 11 measures an index indicating a size of each of all the cells included in one image, for example, an area, a perimeter, a length (length in a height direction (longitudinal direction)), a width (width in a lateral direction (direction orthogonal to the longitudinal direction)), a ratio of the length and the width of the cell, and the like, based on a specified region (region where the cells are imaged), and calculates a statistic, for example, an average value in the index such as a measured area, as the cell feature data.

The cell feature extraction unit 11 extracts, as the cell feature data, an index indicating brightness of each of all the cells included in one image, for example, an average value, a standard deviation, or a variation coefficient of brightness in a region surrounded by a contour based on the contour of the cell. In addition, the cell feature extraction unit 11 calculates a representative value (for example, an average value of brightness) indicating brightness of the cells for each cell, and calculates a statistic indicating the brightness of the cell, for example, an average value, as the cell feature data based on the index in the cells.

The cell feature extraction unit 11 may use the number of days for which the cells imaged in the training tissue image GF are cultured as the cell feature data. The cell feature extraction unit 11 may acquire the feature of the cells along time series in which the cells are cultured as the cell feature data. For example, the cell feature extraction unit 11 acquires the cell feature data from a cell image of the cells on the first day of culture, and also acquires the cell feature data from a cell image of the cells on the second day of culture, in which the cell feature data is acquired on the first day of culture. The cell feature extraction unit 11 may use a change in the feature acquired on the first day of culture and the second day of culture as the cell feature data.

Here, a process of acquiring the tissue feature data from the training tissue image GF, which is performed in the analysis phase, will be further described. As shown in FIG. 4, the feature of the tissue, which is extracted from the training tissue image GF, may be used as the tissue feature data. In this case, the tissue feature extraction unit 12 of the analysis device 10 acquires the feature of the tissue from the training tissue image GF.

The tissue feature extraction unit 12 acquires, for example, the quality such as good or bad (described as “Grade” in FIG. 4) of the tissue imaged in the training tissue image GF as tissue feature data.

The tissue feature extraction unit 12 acquires, for example, the quality such as good or bad obtained by evaluating the tissue imaged in the training tissue image GF by a user (human) who visually recognizes the tissue, as the tissue feature data. Alternatively, the tissue feature extraction unit 12 may acquire a determination result obtained by determining the quality based on the tissue feature data, for example, an area of the vascular network as the tissue feature data.

In addition, the tissue feature extraction unit 12 may determine the quality such as good or bad by using a machine learning method. A method in which the tissue feature extraction unit 12 determines whether the quality is good or bad by using the machine learning method will be described later in detail.

Note that the quality evaluation unit 13 may perform determination as to whether the quality of the tissue is good or bad (for example, determination using the machine learning method).

In addition, the tissue feature extraction unit 12 acquires a statistic, such as a size or a shape of the tissue as the tissue feature data. In a case where the cell tissue has a vascular network structure, the tissue feature data may be information indicating a feature of the vascular network. In this case, for example, the tissue feature data is a statistic such as whether the quality of the vascular network imaged in the tissue image is good or bad, the degree of density of the vascular network, or the shape thereof.

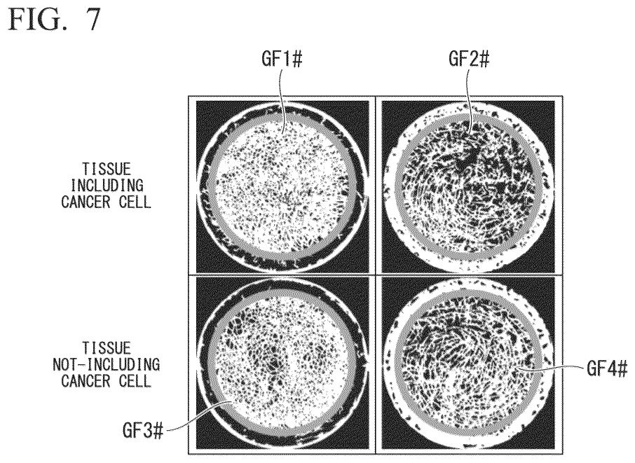

The tissue feature extraction unit 12 performs image processing for extracting the tissue, for example, thinning processing, on the training tissue image GF to specify a region where the vascular network is imaged in the image. For example, the tissue feature extraction unit 12 generates, from training tissue images GF1 to GF4 (refer to FIG. 6), training tissue images GF1 # to GF4 # (refer to FIG. 7) in which a region where the tissue is imaged in the training tissue images GF1 to GF4 is specified.

The tissue feature extraction unit 12 classifies a region (vascular network structure region) where the tissue is imaged in the image and a region (non-vascular network structure region) where no tissue is imaged in the image based on the training tissue image GF in which the region where the tissue is imaged is specified. For example, the tissue feature extraction unit 12 divides the training tissue image GF into a plurality of regions. In a case where a contour of a container accommodating the tissue during the culture process is circular when viewed in an imaging direction, for example, the tissue feature extraction unit 12 equally divides the tissue image into sectors having the same central angle such that the center of the image is set to a center. The tissue feature extraction unit 12 classifies the vascular network structure region and the non-vascular network structure region in each of the equally divided small regions.

The tissue feature extraction unit 12 calculates an index indicating the size of the vascular network structure region in each of the equally divided small regions, for example, an area of the vascular network structure region in the small region, and calculates, as the tissue body feature data, a statistic of the calculated area, for example, an average value and a variance value of the area, a ratio of the number of small regions where a difference from the average value is equal to or greater than the variance value to the total number of the divided small regions, and the like.

In addition, the tissue feature extraction unit 12 may extract a total length of the vascular network as the tissue as the tissue feature data. For example, the tissue feature extraction unit 12 performs thinning processing to classify a region of the vascular network, and sets the number of pixels having a pixel value corresponding to the vascular network among thinned portions classified as the vascular network as the total length of the vascular network.

In addition, the tissue feature extraction unit 12 may extract, as the tissue feature data, the number of end points and the number of branch points of the vascular network as the tissue. For example, the tissue feature extraction unit 12 performs the thinning processing to classify the region of the vascular network. The tissue feature extraction unit 12 performs pattern recognition or the like to acquire the end points and the branch points of the thinned portion classified as the vascular network. The tissue feature extraction unit 12 sets the acquired number of end points and number of branch points, a ratio of the number of end points to the number of branch points, and the like as the tissue feature data.

Note that the tissue feature extraction unit 12 may calculate, as the tissue feature data, a statistic of an area of the vascular network structure region in each of the equally divided small regions even in the training tissue image GF before the thinning processing.

In addition, the tissue feature extraction unit 12 may calculate a statistic of an area of the non-vascular network structure region as the tissue feature data. For example, the tissue feature extraction unit 12 calculates a statistic of the area of the non-vascular network structure region in each of the equally divided small regions by using the training tissue image GF before the thinning processing.

The tissue feature extraction unit 12 calculates an index indicating the size of the non-vascular network structure region in each of the equally divided small regions, for example, the area of the non-vascular network structure region in the small region, and calculates a statistic of the calculated area, for example, an average value and a variance value of the area, a ratio of the number of small regions where a difference from the average value is equal to or greater than the variance value to the total number of the divided small regions, and the like as the tissue feature data.

In a case where a plurality of non-vascular network structure regions are present in each of the equally divided small regions, the tissue feature extraction unit 12 may calculate an average value and a variance value of the area of the non-vascular network structure regions, and a ratio of the number of non-vascular network structure regions where a difference from the average value is equal to or greater than the variance value to the total number of the non-vascular network structure regions present in the small region as the tissue feature data. In this case, the tissue feature extraction unit 12 may calculate, as a statistic of a statistic of each of the small regions, for example, a statistic of a variance value (first variance value) of an area of the plurality of non-vascular network structure regions present in each of the small regions, an average value, a variance value, and a variation coefficient of the first variance value, a ratio of the number of the small regions where a difference from the average value is equal to or greater than the variance value to the total number of the small regions, and the like as the tissue feature data.

FIG. 5 is a diagram showing an example of the training cell image GC according to the embodiment. FIG. 5 shows an example of the training cell image GC1 before performing image processing and the training cell image GC1 # after performing the image processing on the training cell image GC1. The image processing stated here is region-specifying processing of specifying a region where a single cell or a cell population is imaged in the image. The region-specifying processing is performed by using, for example, a contour extraction filter (hereinafter, referred to as a cell image analysis filter) that extracts a shape similar to the single cell or the cell population.

Here, the size and the shape of the cell vary depending on a type of the cell. In the prediction system 1, it is desirable that the cell image analysis filter suitable for the cell is selected in advance.

In order to select the suitable cell image analysis filter, in the prediction system 1, for example, a plurality of filters in which setting of internal parameters or the like is changed are prepared. In addition, by variously combining the number of subcultures, lots, and the like, a cell image obtained by imaging cells in which a plurality of types of cells having different roots are cultured is prepared. It is desirable that the number of cell images prepared here satisfies targeted prediction accuracy, generalization performance, and the like in the constructed prediction system 1.

The cell image analysis filter is applied to each of the cell images, and whether or not a single cell or a cell population is correctly extracted from the cell image is determined by, for example, visual observation. A cell image analysis filter in which the probability that the single cell or the cell population is correctly extracted is less than a threshold value is selected as the suitable cell image analysis filter. The threshold value stated here may be arbitrarily set according to the targeted performance in the prediction system 1.

FIGS. 6 and 7 are diagrams showing an example of the training tissue image GF of the embodiment. FIG. 6 shows the training tissue images GF1 to GF4 before performing image processing. FIG. 7 shows the training tissue images GF1 # to GF4 # obtained by performing the image processing on the training tissue images GF1 to GF4 of FIG. 6 according to the embodiment. The image processing stated here is processing of specifying a region where a vascular network is imaged in an image. For example, a process of extracting a mesh of the vascular network (hereinafter, referred to as a vascular network analysis filter) is executed using thinning processing or the like.

Here, in a case of evaluating drug efficacy of an anti-cancer agent or the like, a three-dimensional cell tissue including cancer cells, which is obtained by seeding and culturing cancer cells in the three-dimensional cell tissue, can also be used. In the prediction system 1, it is desirable that a vascular network analysis filter suitable for both a three-dimensional cell tissue not including cancer cells and a three-dimensional cell tissue including cancer cells is selected. In addition, the evaluation of the drug efficacy can also be carried out, for example, by using a size of an area of the cancer cells as an index. From such a viewpoint, it is possible to evaluate the drug efficacy even in a case where a formation state of the vascular network in the three-dimensional cell tissue or the quality of the vascular network is not evaluated. That is, the tissue feature data may be extracted from a viewpoint of evaluating the drug efficacy. For example, the tissue feature data in the three-dimensional cell tissue may be acquired by using, as an index, a degree of ease of recognizing proliferation of cancer cells or extinction of cancer cells, instead of the presence or absence of the vascular network.

In FIG. 6, a tissue image in a three-dimensional cell tissue including cancer cells (in FIG. 6, simply referred to as a “tissue including cancer cells”) is shown in an upper portion thereof. A tissue image in a three-dimensional cell tissue not including cancer cells (in FIG. 6, simply described as a “tissue not including cancer cells”) is shown in a lower portion thereof. Images of the three-dimensional cell tissue including cancer cells are shown in the training tissue images GF1 and GF2. Images of the three-dimensional cell tissue not including cancer cells are shown in the training tissue images GF3 and GF4.

Similarly, in FIG. 7, the training tissue image GF1 # shows an image obtained by applying the vascular network analysis filter to the training tissue image GF1. The training tissue image GF2 # shows an image obtained by applying the vascular network analysis filter to the training tissue image GF2. The training tissue image GF3 # shows an image obtained by applying the vascular network analysis filter to the training tissue image GF3. The training tissue image GF4 # shows an image obtained by applying the vascular network analysis filter to the training tissue image GF4.

In the prediction system 1, a vascular network analysis filter in which a mesh of the vascular network is appropriately extracted is selected regardless of whether or not the cancer cells are included. Alternatively, in a case where a result of extracting the mesh of the vascular network by using a vascular network analysis filter is significantly different depending on whether or not a tissue includes cancer cells, the vascular network analysis filter is not adopted, or different vascular network analysis filters are adopted for the tissue including cancer cells and the tissue not including cancer cells.

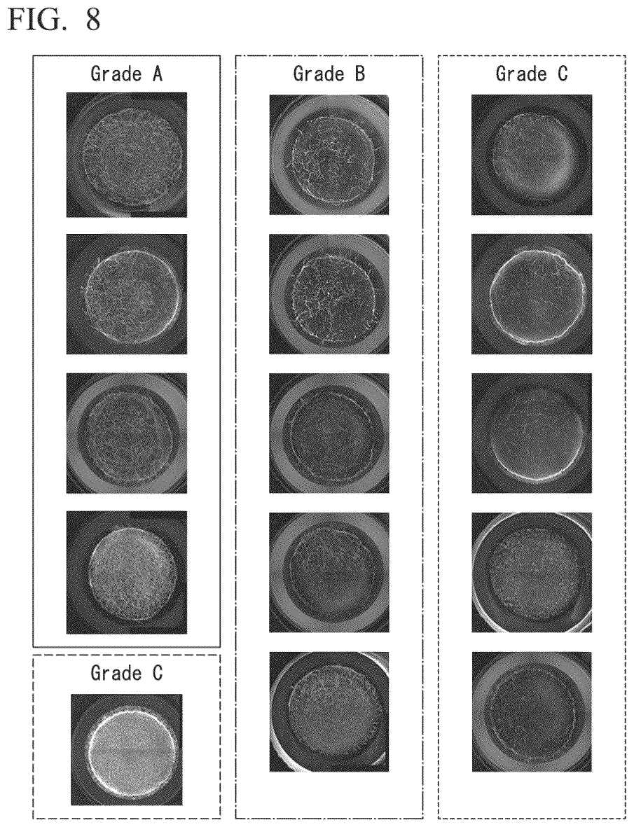

Here, a method of evaluating the quality of the vascular network tissue will be described with reference to FIGS. 8 to 11. FIGS. 8 to 11 are diagrams showing an example of the quality evaluation of the training tissue image GF according to the embodiment.

Note that the quality evaluation unit 13 may perform the quality evaluation of the training tissue image GF of the embodiment.

In FIG. 8, tissue images and quality evaluation results are associated with each other. In the example of the drawing, an example in which the quality is classified into any one of three stages of Grade A, Grade B, and Grade C is shown.

Here, FIG. 8 shows a result of determining the quality such as good or bad of a vascular network from an image (vascular network image) in which the vascular network is imaged by using a machine learning method. In this way, the prediction system 1 may be configured to determine the quality such as good or bad of the vascular network from the vascular network image by using the machine learning method.

For example, a plurality of images in which the vascular network is imaged are prepared. Then, a formation state of the vascular network in each of the vascular network images is scored by visual observation of a user or the like. A clustering analysis is performed by using a scored vascular network image, and the quality of the vascular network is classified into groups such as Grade X, Grade Y, and Grade Z. A determination model that determines whether the quality of the vascular network is good (OK) or bad (NG) is generated by using the vascular network image used in the clustering analysis as training data. Any machine learning method may be used as a method of generating the determination model. For example, the determination model is a model configured to estimate a probability that the vascular network shown in an unlearned vascular network image has quality of Grade A. In addition, the determination model is a model configured to estimate a probability that the vascular network shown in the unlearned vascular network image has quality of Grade C. The tissue feature extraction unit 12 may determine whether the quality of a cell tissue such as the vascular network is good or bad by using the determination model created in this way.

For example, it is determined that the quality of the vascular network is Grade X in a case where the probability of being Grade A is equal to or greater than a threshold value. On the other hand, it is determined that the quality of the vascular network is Grade Z in a case where the probability of being Grade C is equal to or greater than a threshold value. The others are determined as Grade Y.

FIG. 8 is a diagram showing an example of the quality evaluation of the training tissue image GF according to the embodiment. In FIG. 8, tissue images and quality evaluation results are associated with each other. In the example of the drawing, an example in which the quality is classified into any one of three stages of Grade A, Grade B, and Grade C is shown.

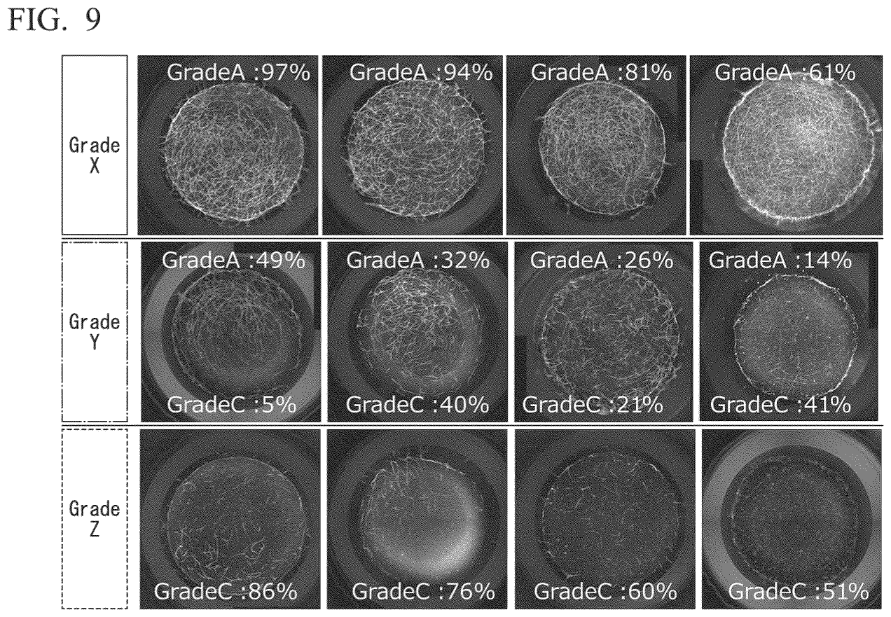

FIG. 9 shows a probability of being Grade A and a probability of being Grade C for each of the vascular network images classified into any one of Grade A, Grade B, and Grade C.

In this case, a determination threshold value for determining the quality such as good or bad of the vascular network may be set based on determination results of the determination model, that is, whether it is Grade A, Grade B, or Grade C.

For example, in the example of the drawing, it is determined that the quality of the vascular network is good (OK) for the vascular network image of Grade A or Grade B. On the other hand, it is determined that the quality of the vascular network is bad (NG) for the vascular network image of Grade C.

Note that the present disclosure is not limited to the example of the drawing, and for example, the quality of the vascular network may be determined to be good (OK) for the vascular network image of Grade A, and the quality of the vascular network may be determined to be bad (NG) for the vascular network image of Grade B or Grade C. The quality of the vascular network may be determined to be good (OK) for the vascular network image of Grade C, and the quality of the vascular network may be determined to be bad (NG) for the vascular network image of Grade A. The quality is not necessarily good in a case where the vascular network is large, and the quality such as good or bad of the tissue may be optionally determined depending on the performance and the quality required for the tissue.

Here, in the prediction system 1, accuracy of prediction in the vascular network prediction model may be evaluated by using a determination model. In this case, first, a vascular network image is prepared. In addition, a cell image of the pre-culture (first process in FIG. 2) in the prepared vascular network image is prepared.

Next, the quality of a vascular network shown in the vascular network image is determined to be good or bad from the vascular network image by using the determination model. Further, the quality of a vascular network to be produced by culturing cells shown in the cell image is determined to be good or bad from the cell image by using the vascular network prediction model. A determination is made as to whether or not a determination result using the determination model matches a determination result using the vascular network prediction model. In a case of matching, it is determined that the vascular network prediction model has made a correct prediction. On the other hand, in a case of not-matching, it is determined that the vascular network prediction model has made an erroneous prediction. For example, a ratio of the number of cell images for which the vascular network prediction model has made a correct prediction to the total number of cell images used for the determination is used as an index indicating the accuracy of prediction of the vascular network prediction model.

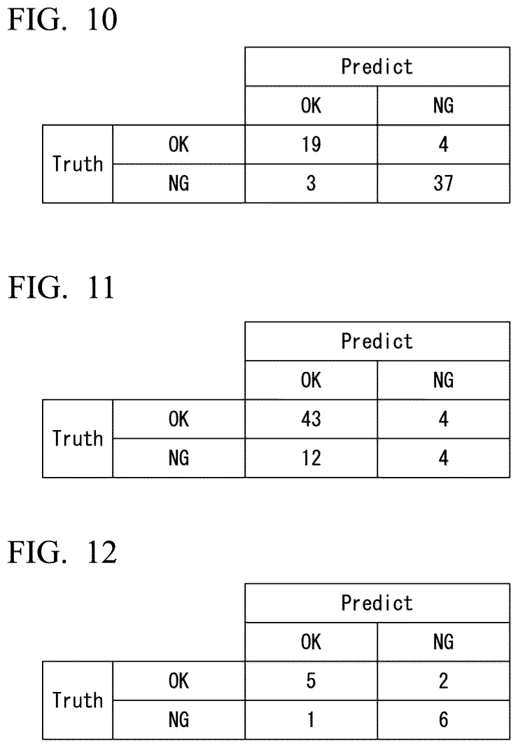

FIGS. 10 and 11 show evaluation results obtained by evaluating the accuracy of prediction in the vascular network prediction model.

In FIG. 10, the quality of the vascular network of the vascular network image is determined to be good (OK) or bad (NG) based on a certain specific condition.

On the other hand, in FIG. 11, the quality of the vascular network of the vascular network image is determined to be good (OK) or bad (NG) based on a condition different from that in FIG. 10.

In FIGS. 10 and 11, the determination result in the determination model is shown in a horizontal direction as “Truth”. The determination result in the vascular network prediction model is shown in a vertical direction as “Predict”. In addition, FIGS. 10 and 11 show an example in which 63 images were used for the determination.

As shown in FIG. 10, the determination result of the determination model and the determination result of the vascular network prediction model matched each other in a determination result that the quality of the vascular network was good (OK) on 19 images, and did not match each other in the determination result that the quality of the vascular network was good (OK) on 4 images. That is, the probability of matching in the determination result that the quality of the vascular network was good (OK) was approximately 83% (=19/(19+4)×100).

On the other hand, as shown in FIG. 10, the determination result of the determination model and the determination result of the vascular network prediction model matched each other in a determination result that the quality of the vascular network was bad (NG) on 37 images, and did not match each other in the determination result that the quality of the vascular network was bad (NG) on 3 images. That is, the probability of matching in the determination result that the quality of the vascular network was bad (NG) was approximately 93% (=37/(37+3)×100).

As shown in FIG. 11, the determination result of the determination model and the determination result of the vascular network prediction model matched each other in a determination result that the quality of the vascular network was good (OK) on 43 images, and did not match in the determination result that the quality of the vascular network was good (OK) on 4 images. That is, the probability of matching in the determination result that the quality of the vascular network was good (OK) was approximately 91% (=43/(43+4)×100).

On the other hand, as shown in FIG. 11, the determination result using the determination model and the determination result using the vascular network prediction model matched each other in a determination result that the quality of the vascular network was bad (NG) on 4 images, and did not match each other in the determination result that the quality of the vascular network was bad (NG) on 12 images. That is, the probability of matching in the determination result that the quality of the vascular network was bad (NG) was 25% (=4/(4+12)×100).

In FIG. 11, in the determination model, the probability that the quality of the vascular network was bad (NG), that is, the quality was determined as Grade Cis approximately 25% ((12+4)/(43+4+12+4)×100). In addition, in FIG. 11, the probability that the determination model and the vascular network prediction model matched each other in the determination result that the quality of the vascular network was bad (NG) is 25%.

Description will be given of a result of evaluating the accuracy of prediction in the vascular network prediction model by reviewing conditions under which the evaluation results shown in FIG. 11 are obtained.

FIG. 12 shows a result of evaluating the accuracy of prediction in the vascular network prediction model by reviewing the conditions under which the evaluation results shown in FIG. 11 are obtained. In the evaluation shown in FIG. 12, 14 images are used for determination.

Since a noise in the tissue image or ambiguity in criteria (Grade criteria) for determining the quality of the tissue (vascular network) may affect the accuracy of prediction, the following items were reviewed. That is, data (training data) for training the determination model, the vascular network analysis filter for the tissue image, and vascular network quality determination criteria (Grade determination criteria) were reviewed.

As shown in FIG. 12, the determination result of the determination model and the determination result of the vascular network prediction model matched each other in a determination result that the quality of the vascular network was good (OK) on 5 images, and did not match each other in the determination result that the quality of the vascular network was good (OK) on 2 images. That is, the probability of matching in the determination result that the quality of the vascular network was good (OK) is approximately 71% (=5/(5+2)×100).

On the other hand, as shown in FIG. 12, the determination result of the determination model and the determination result of the vascular network prediction model matched each other in a determination result that the quality of the vascular network was bad (NG) on 6 images, and did not match each other in the determination result that the quality of the vascular network was bad (NG) on 1 image. That is, the probability of matching in the determination result that the quality of the vascular network was bad (NG) was 86% (=6/(6+1)×100).

By reviewing the above-described items, in the evaluation results of FIG. 12, the probability of matching (hereinafter, referred to as an NG hitting ratio) in the determination result that the quality of the vascular network was bad (NG) is significantly improved as compared with the evaluation results shown in FIG. 11. That is, the NG hitting ratio in FIG. 11 is 25%, whereas the NG hitting ratio in FIG. 12 is improved to 86%.

As described above, in the present embodiment, the quality of the vascular network is determined by using the determination model using the machine learning method, and the vascular network prediction model is trained by using the tissue feature data including the determination result of the quality of the vascular network, but the following first and second modification examples may be adopted.

In the first modification example, the quality of the vascular network is determined by using a deviation criterion (threshold value) instead of the determination model using the machine learning method. Among tissue feature data that can be acquired by performing, for example, image processing on the training tissue image, an item represented by a numerical value is selected. The item of the tissue feature data to be used may be appropriately selected in correspondence with performance of a target tissue, a structure of the vascular network, and the like.

The deviation criterion (threshold value) is set for the selected item. This deviation criterion may also be appropriately adjusted in correspondence with the performance of the target tissue, the structure of the vascular network, and the like.

When determining the quality of the vascular network by using the above-described deviation criterion, it is possible to limit an influence of “ambiguity” of image determination by a user or accuracy of the determination model using the machine learning method on the accuracy of the determination of the quality of the vascular network.

In the second modification example, the quality of the vascular network is determined by using an MT method using data determined by the deviation criterion instead of the determination model using the machine learning method. In the MT method, a population of data selected in correspondence with a purpose is defined as a unit space, and a Mahalanobis distance (MD) of the tissue feature data that is a determination target from the center of the unit space is obtained. It can be determined that a configuration is close to the unit space when the MD is small, and the configuration is far from the unit space when the MD is large. In the present modification example, the phrase “population of data selected in correspondence with a purpose” corresponds to data determined not to deviate from the deviation criterion in the tissue feature data in the first modification example described above. As described above, since the unit space consists of a population of data selected in correspondence with the purpose, it can be determined that the purpose is satisfied, that is, the quality of the vascular network is good when the MD is small.

According to the determination of the quality of the vascular network by using the above-described MT method, it is possible to limit an influence of “ambiguity” associated with image determination by the user or the accuracy of the determination model using the machine learning method on the accuracy of the determination of the quality of the vascular network. In addition, it is possible to check how much the tissue feature data that is a determination target deviates from the criterion of a good product (that is, the unit space) instead of determining only the quality such as good or bad of the vascular network.

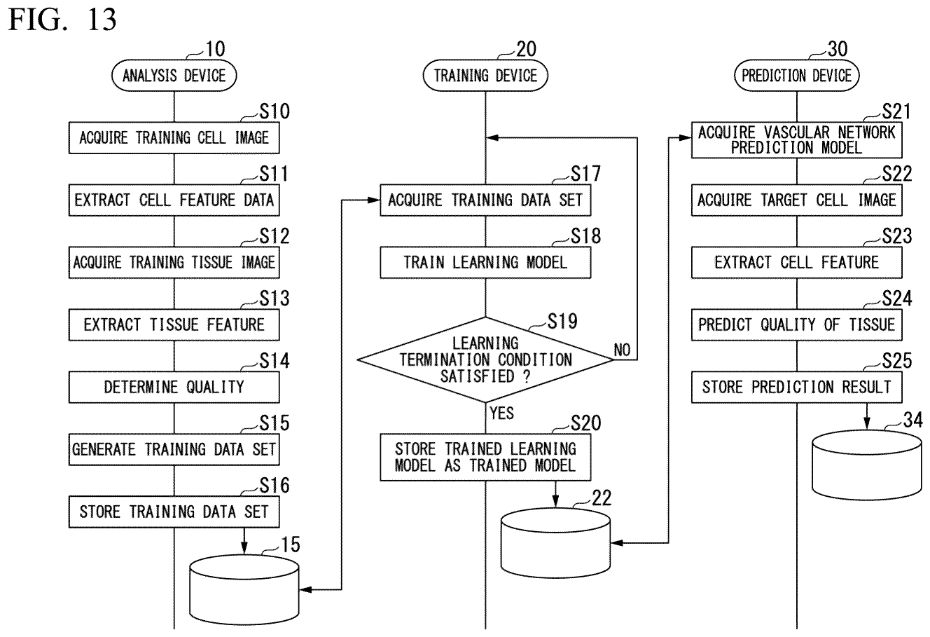

Here, a flow of a process performed by the prediction system 1 of the embodiment will be described with reference to FIG. 13. FIG. 13 is a sequence diagram showing the flow of the process performed by the prediction system 1 of the embodiment.

First, the analysis device 10 acquires image data of the training cell image GC (step S10). The analysis device 10 extracts cell feature data from the training cell image GC by using a cell analysis filter or the like (step S11). On the other hand, the analysis device 10 acquires image data of the training tissue image GF (step S12). The analysis device 10 extracts the tissue feature data from the training tissue image GF by using a vascular network analysis filter or the like (step S13). In addition, the analysis device 10 determines a quality of a tissue shown in the training tissue image GF (step S14). The analysis device 10 may determine the quality of the tissue based on the tissue feature data, or may determine the quality of the tissue by using the determination model.

The analysis device 10 generates a training data set by associating the cell feature data with the tissue feature data (step S15). The analysis device 10 stores the generated training data set in the training data set storage unit 15 (step S16).

The training device 20 acquires the training data set with reference to the training data set storage unit 15 (step S17). The training device 20 causes a learning model to learn a correspondence relationship between the cell feature data and the tissue feature data by using the training data set (step S18). The training device 20 determines whether or not a learning termination condition is satisfied (step S19). The learning termination condition is, for example, that accuracy of prediction by the learning model is equal to or greater than a threshold value, but the present disclosure is not limited thereto, and the learning termination condition may be set arbitrarily.

When the learning termination condition is satisfied, the training device 20 stores the trained learning model in the trained model storage unit 22 as a trained model (step S20). On the other hand, when the learning termination condition is not satisfied, the training device 20 returns to step S17 and repeats the learning.

The prediction device 30 acquires a vascular network prediction model with reference to the trained model storage unit 22 or the like (step S21). The prediction device 30 acquires image data of the target cell image TC (step S22). The prediction device 30 extracts cell feature data from the target cell image TC by using the cell analysis filter or the like (step S23). The prediction device 30 predicts the quality of a cell tissue to be produced by culturing cells shown in the target cell image TC (step S24). The prediction device 30 predicts a prediction value output from the vascular network prediction model as the quality of the cell tissue, for example, by inputting the cell feature data extracted from the target cell image TC to the vascular network prediction model. The prediction device 30 stores the prediction result in the prediction result storage unit 34.

As described above, the analysis device 10 of the embodiment includes the cell feature extraction unit 11 (first acquisition unit), the tissue feature extraction unit 12 (second acquisition unit), and the training data set generation unit 14 (generation unit). The cell feature extraction unit 11 acquires cell feature data indicating a feature of a cell (training cell) based on the training cell image GC (cell image). The cell image is an image obtained by imaging cells that can become a cell tissue having a vascular network structure. The tissue feature extraction unit 12 acquires tissue feature data indicating a feature of a tissue (training tissue) based on the training tissue image GF (tissue image). The tissue image is an image obtained by imaging a cell tissue produced by culturing cells (training cells). The training data set generation unit 14 generates a training data set (correspondence data). The training data set is information in which the cell feature data and the tissue feature data are associated with each other.

As a result, in the analysis device 10 of the embodiment, it is possible to generate information (training data set) in which the cell feature data and the tissue feature data are associated with each other. Therefore, by training a learning model with the training data set, it is possible to generate a trained model that predicts the feature of the tissue based on the cell feature data. That is, it is possible to predict the characteristics of the cell tissue to be produced from cells at the initial stage of starting the culture of the cells.

In addition, in the analysis device 10 of the embodiment, the cell feature data is image data of the training cell image GC (cell image). The tissue feature data is image data of the training tissue image GF (tissue image). As a result, in the analysis device 10 of the embodiment, the image itself in the training cell image GC (cell image) can be set as the feature of the cell. In addition, the image itself in the training tissue image GF (tissue image) can be set as the feature of the tissue. It is possible to generate a trained model that has learned the feature of these images.

In addition, in the analysis device 10 of the embodiment, the cell feature data is data indicating at least one feature of a size, brightness, and a shape of the cell imaged in the training cell image GC (cell image). Accordingly, in the analysis device 10 of the embodiment, at least any one of the size, the brightness, and the shape of the cell in the image can be set as the feature of the cell, and a trained model in which such a feature of the cell is learned can be generated.

In addition, in the analysis device 10 of the embodiment, the tissue feature data is data indicating at least one feature of a size and a shape of a vascular network structure region having a vascular network structure in the training tissue image GF (tissue image). As a result, in the analysis device 10 of the embodiment, at least any one of the size and the shape of the vascular network structure region in the image can be set as the feature of the tissue, and it is possible to generate a trained model that has learned such a feature of the tissue.

In addition, in the analysis device 10 of the embodiment, the tissue feature data is data indicating a feature of a size of a non-vascular network structure region that does not have the vascular network structure in the training tissue image GF (tissue image). As a result, in the analysis device 10 of the embodiment, the size of the non-vascular network structure region in the image can be set as the feature of the tissue, and it is possible to generate a trained model that has learned such a feature of the tissue.

In addition, in the analysis device 10 of the embodiment, the tissue feature data is data indicating the quality of a cell tissue imaged in the training tissue image GF (tissue image). As a result, in the analysis device 10 of the embodiment, the quality of the vascular network can be set as the feature of the tissue, and it is possible to generate a trained model that has learned such a feature of the tissue.

In addition, the prediction system 1 of the embodiment includes the analysis device 10, the trained model generation unit 21, the cell feature extraction unit 31, and the prediction unit 32. The trained model generation unit 21 generates a trained model. The trained model is a model that predicts the feature of a cell tissue to be produced from a target cell based on the target cell image TC. The trained model generation unit 21 generates the trained model by causing a learning model to learn a correspondence relationship between a cell and a cell tissue by using the training data set. The cell feature extraction unit 31 acquires cell feature data of a cell based on the target cell image TC. The prediction unit 32 predicts the feature of a cell tissue to be produced by culturing a target cell by using the trained model (vascular network prediction model). As a result, in the prediction system 1 according to the embodiment, it is possible to predict the feature of a tissue to be produced from a cell based on the feature of the cell. That is, it is possible to predict the characteristics of a cell tissue to be produced from a cell at the initial stage of starting culture of the cell.

The whole or a part of the prediction system 1 and the analysis device 10 in the above-described embodiment may be configured of a computer. In this case, a program for realizing functions thereof may be recorded on a computer-readable recording medium, and a computer system may read and execute the program recorded on the recording medium to realize the functions. Note that the term “computer system” described herein includes an OS and hardware such as a peripheral device. In addition, the term “computer-readable recording medium” includes, for example, a portable medium such as a flexible disk, a magneto-optical disk, a ROM, and CD-ROM, a storage device such as a hard disk embedded in a computer system, or the like. Furthermore, the term “computer-readable recording medium” may include a thing that dynamically stores a program for a short period of time such as a communication line when transmitting the program through a network such as the Internet or a communication line such as a telephone line, and a thing that stores a program for a certain period of time such as a server or a volatile memory in a computer system that serves as a server or a client in that case. In addition, the above program may realize a part of the above-described functions, may further realize the above-described functions in combination with a program previously recorded in a computer system, or may be realized by using a programmable logic device such as an FPGA.

As described above, although the embodiment of the present invention has been described in detail with reference to the drawings, the specific configuration is not limited to the embodiment and also includes design and the like within the scope of the present invention.

### REFERENCE SIGNS LIST

1 Prediction system
10 Analysis device
11 Cell feature extraction unit (first acquisition unit)
12 Tissue feature extraction unit (second acquisition unit)
13 Quality evaluation unit
14 Training data set generation unit (generation unit)
15 Training data set storage unit
20 Training device
21 Trained model generation unit
22 Trained model storage unit
30 Prediction device
31 Cell feature extraction unit
32 Prediction unit
33 Vascular network prediction model storage unit
34 Prediction result storage unit

What is claimed is:

1. An analysis device comprising:
a first acquisition circuitry configured to acquire cell feature data indicating a feature of a training cell that is a cell to be a cell tissue having a vascular network structure based on a cell image obtained by imaging the training cell;
a second acquisition circuitry configured to acquire tissue feature data indicating a feature of a training tissue that is a cell tissue produced by culturing the training cell; and
a generation circuitry configured to generate correspondence data in which the cell feature data and the tissue feature data are associated with each other.

2. The analysis device according to claim 1,
wherein the cell feature data is image data of the cell image.

3. The analysis device according to claim 1,
wherein the second acquisition circuitry acquires, as the tissue feature data, a feature of a tissue image that is an image obtained by imaging the training tissue.

4. The analysis device according to claim 1,
wherein the cell feature data is data indicating at least one feature selected from the group consisting of a size, brightness, and a shape of a cell imaged in the cell image.

5. The analysis device according to claim 1,
wherein the tissue feature data is data indicating at least one feature of an evaluation result and a determination result based on a size and a shape of a vascular network structure region having a vascular network structure in the training tissue, and a quality of the training tissue.

6. The analysis device according to claim 1,
wherein the tissue feature data is data indicating at least one of a size, a shape of a vascular network structure region having a vascular network structure of the training tissue, and a quality of the training tissue determined based on at least one of the size and the shape.

7. The analysis device according to claim 1,
wherein the tissue feature data is data indicating at least one of a total length of a vascular network of the training tissue, and a quality of the training tissue determined based on the total length.

8. The analysis device according to claim 1,
wherein the tissue feature data is data indicating at least one of a number of end points, a number of branch points of a vascular network of the training tissue, and a quality of the training tissue determined based on at least one of the number of end points and the number of branch points.

9. The analysis device according to claim 1,
wherein the tissue feature data is data indicating a quality of the training tissue determined by using a determination model using a machine learning method.

10. The analysis device according to claim 1,
wherein the tissue feature data is data indicating a feature of a size of a non-vascular network structure region having no vascular network structure in the training tissue.

11. A prediction system comprising:
the analysis device according to claim 1;
a trained model generation circuitry configured to generate a trained model for predicting a feature of a cell tissue to be produced from a target cell based on a target cell image obtained by imaging the target cell that is an estimation target by causing a learning model to learn a correspondence relationship between the cell and the cell tissue by using the correspondence data generated by the analysis device as a training data set;
a third acquisition circuitry configured to acquire target cell feature data based on the target cell image, and
a prediction circuitry configured to predict the feature of the cell tissue to be produced by culturing the target cell by using the trained model generated by the trained model generation circuitry.

12. A prediction method to be executed by a computer, the method comprising:
acquiring, by a first acquisition circuitry, cell feature data indicating a feature of a training cell that is a cell to be a cell tissue having a vascular network structure based on a cell image obtained by imaging the training cell;
acquiring, by a second acquisition circuitry, tissue feature data indicating a feature of a training tissue that is a cell tissue produced by culturing the training cell;
generating, by a generation circuitry, correspondence data in which the cell feature data and the tissue feature data are associated with each other;
generating, by a trained model generation circuitry, a trained model that predicts a feature of a cell tissue to be produced from a target cell based on a target cell image obtained by imaging the target cell that is an estimation target by causing a learning model to learn a correspondence relationship between the cell and the cell tissue by using the correspondence data as a training data set;
acquiring, by a third acquisition circuitry, target cell feature data based on the target cell image; and
predicting, by a prediction circuitry, the feature of the cell tissue to be produced by culturing the target cell by using the trained model generated by the trained model generation circuitry.

13. A prediction system comprising:
an analysis device, a training device, and a prediction device,
wherein the analysis device comprises:
a first cell feature extraction circuitry configured to receive a training cell image from a first imaging terminal and to extract cell feature data therefrom;
a tissue feature extraction circuitry configured to receive a training tissue image from a second imaging terminal and to extract tissue feature data therefrom;
a training data set generation circuitry communicatively coupled to the first cell feature extraction circuitry and the tissue feature extraction circuitry, the training data set generation circuitry being configured to generate a training data set by associating the cell feature data and the tissue feature data; and
a training data set storage circuitry configured to store the training data set generated by the training data set generation circuitry,
wherein the training device comprises:
a trained model generation circuitry communicatively coupled to the training data set storage circuitry, the trained model generation circuitry being configured to generate a trained model by training a learning model with the training data set; and
a trained model storage circuitry configured to store the trained model generated by the trained model generation circuitry, and
wherein the prediction device comprises:
a second cell feature extraction circuitry configured to receive a target cell image from a third imaging terminal and to extract target cell feature data therefrom;
a prediction circuitry communicatively coupled to the second cell feature extraction circuitry and the trained model storage circuitry, the prediction circuitry being configured to predict a feature of a cell tissue by inputting the target cell feature data to the trained model; and
a prediction result storage circuitry configured to store a prediction result from the prediction circuitry.
